(19) United States
(12) Patent Application Publication
(10) Pub. No.: US 2015/0288711 A1
(43) Pub. Date: Oct. 8, 2015

(54) NETWORK ANALYSIS APPARATUS AND METHOD

(71) Applicant: The Sylint Group, Sarasota, FL (US)

(72) Inventor: Serge Durand Jorgensen, Sarasota, FL (US)

(73) Assignee: The Sylint Group, Sarasota, FL (US)

(21) Appl. No.: 14/244,517

(22) Filed: Apr. 3, 2014

(51) Int. Cl. H04L 29/06

(52) U.S. Cl. CPC H04L 63/1425; H04L 63/1416

(57) ABSTRACT

A system, method, and computer-readable storage medium configured to collect, parse and monitor Domain Name System information from a network and black hole identified suspect or bad FQDNs and whitelisting good domains.

### BACKGROUND

1. Field of the Disclosure

Aspects of the disclosure relate in general to computer networking. Aspects include an apparatus, a method and system to collect, parse and monitor Domain Name System information from a network.

2. Description of the Related Art

The Domain Name System (DNS) is a hierarchical distributed naming system for computers, services, resources connected to the Internet or a private network. DNS serves as the “phone book” for the Internet by translating domain names to the numerical Internet Protocol (IP) addresses needed for the purpose of locating computer services and devices worldwide. By providing a worldwide, distributed keyword-based redirection service, the Domain Name System is an essential component of the functionality of the Internet.

Unlike a phone book, the DNS can be quickly updated, allowing a service's location on the network to change without affecting the end users, who continue to use the same host name. Users take advantage of this when they use meaningful Uniform Resource Locators (URLs), and e-mail addresses without having to know how the computer actually locates the services.

The Domain Name System distributes the responsibility of assigning domain names and mapping those names to IP addresses by designating authoritative name servers (or “DNS servers”) for each domain. Authoritative name servers are assigned to be responsible for their supported domains, and may delegate authority over sub-domains to other name servers. This mechanism provides distributed and fault tolerant service and was designed to avoid the need for a single central database.

The Domain Name System also specifies the technical functionality of this database service. It defines the DNS protocol, a detailed specification of the data structures and data communication exchanges used in DNS, as part of the Internet Protocol Suite.

### SUMMARY

Embodiments include a system, device, method and computer-readable medium to collect, parse and analyze Domain Name System information from a network and return black hole information to redirect malicious traffic to a harmless destination.

A collection server comprises a network interface and a processor. The network interface is configured to collect DNS log information from a DNS server. The DNS log information includes a DNS lookup entry containing an originating internet protocol address, a fully qualified domain name (FQDN), and a resolved internet protocol address. The processor is configured to extract the DNS lookup entry from the DNS log information, to compare the DNS lookup entry with a malware database entry and to analyze recursive DNS requests made from multiple endpoints to identify new malware. The network interface is further configured to transmit to the originating internet protocol address, via the network interface, a DNS black hole list entry when the resolved internet protocol address or FQDN matches the malware database entry or suspicious characteristics.

### BRIEF DESCRIPTION OF THE DRAWINGS

FIG. 1 is a block diagram illustrating a system to collect, parse and analyze Domain Name System information from a network.

FIG. 2 is an expanded block diagram of an exemplary embodiment of a collection server 2000 (sniffer box) device architecture to collect, parse and analyze Domain Name System information from a network.

FIG. 3 illustrates a method to collect, parse and analyze Domain Name System information from a network.

### DETAILED DESCRIPTION

One aspect of the disclosure includes the realization that while there are many devices and appliances for DNS data collection and analysis as that DNS information passes a firewall or webproxy, no solutions provide a method of collecting and analyzing logs from their instantiation point and returning block information to that same point.

Yet another aspect of the disclosure is the understanding that the current art does not provide for a method of collective log parsing irrespective of initial state, origin and format so that multi-source data can be cross-correlated. Embodiments of the disclosure provide anonymous traffic analysis collected across multiple distinct companies, locations, formats, sources and states.

Embodiments include systems, devices, methods and computer-readable media configured to collect and examine log files both remotely and in situ, and examine traffic in transit.

In a “sniffer box” apparatus embodiment, the apparatus may be installed as another device on any switch in the network. Various devices pre-existing on the network can then be configured to point their log files at the sniffer box (“push”), or for the sniffer box to remotely collect the logs from stated devices (“pull”). In this configuration, the primary function of the sniffer is to allow a central collection point for all available log files. These log files have some amount of parsing, filtering or compression as desired or necessary and then the resultant data set is forwarded to the processing equipment. From here, the log files are parsed or otherwise analyzed, interpreted and made available for display. The resultant dataset and information can be viewed online with a standard set of reports.

While embodiments described herein are applied to a local log file collection and local analysis context, it is understood by those familiar with the art that the apparatus, system and methods described herein may also be applicable to remote examination and analysis of log files. In some embodiments, the process includes log file collection and a remote examination and analysis of the log files. In such an embodiment, log files are moved to a secondary location for parsing and examination. The log collection process provides a buffer between the rates of collection and analysis. Additionally, examination processing power is moved offsite and may be scaled as necessary. In situ examination relies on bidirectional updates for the collection and examination processes, as well as increased onboard processing capability. The examination may occur post-parsing and there remains the potential for a discrepancy between collection rates and analysis rates as the logging process still provides some potential compensation for high-traffic periods. Traffic examination and inspection in transit relies on a managed switch or similar tap into the traffic flow, as well as a network interface card, processor and storage fast enough to analyze the traffic in near-real-time.

The systems and processes are not limited to the specific embodiments described herein. In addition, components of each system and each process can be practiced independently and separately from other components and processes described herein. Each component and process also can be used in combination with other assembly packages and processes.

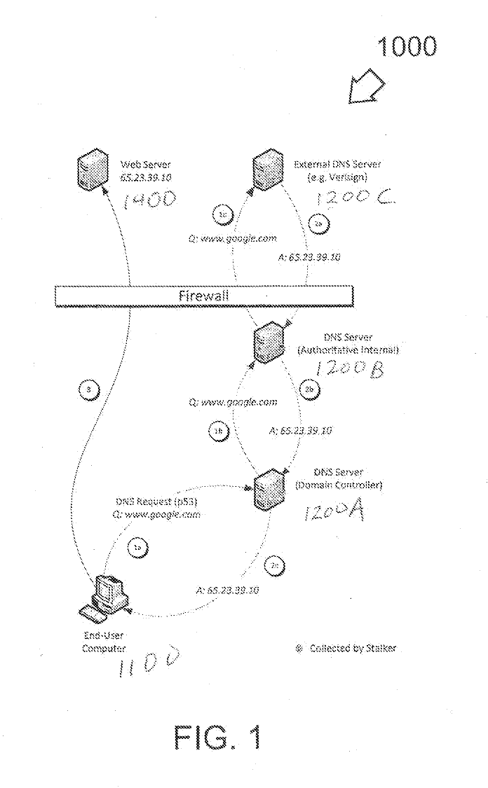

FIG. 1 is a block diagram 1000 illustrating a system to collect, parse and analyze Domain Name System information from a network, constructed in accordance with an embodiment of the present disclosure.

In such a network 1000, an end-user computer 1100 attempts to contact an external web-server 1400. Whenever an end-user computer attempts to contact a particular domain name, such as the external web-server 1400 (in this example, www.google.com), the fully qualified domain name (“FQDN,” or “absolute domain name”) must be translated into an Internet Protocol address. Initially, end-user computer 1100 sends a translation request to a series of DNS servers 1200A-C, messages 1a-1c. Ultimately, the request is sent through the firewall 1300 to an external DNS server 1200C, that replies with the IP address as an answer, messages 2a-2c. Only then the end-user computer 1100 can send traffic to the web-server 1400.

The DNS translation request, along with the requesting computer, is captured in the logs on the DNS server 1200. These logs are parsed and recorded in a relational database by collection server 2000. The relational database may be used to determine which computers are requesting a known- or suspected-bad fully qualified domain name.

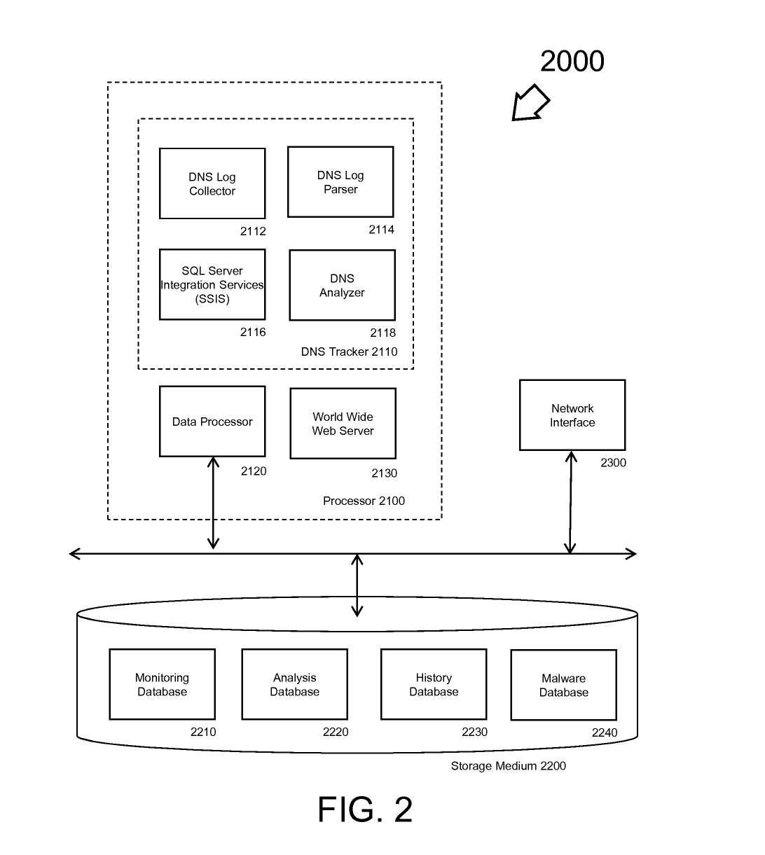

Embodiments will now be disclosed with reference to a block diagram of an exemplary collection server 2000 of FIG. 2, configured to collect, parse and analyze Domain Name System information from a network, constructed and operative in accordance with an embodiment of the present disclosure. It is understood by those familiar with the art, that a collection server 2000 may exist at the same or different domain, as end-user computer 1100 or DNS server 1200A or 1200B.

Collection server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may temporarily store instructions and/or data in Random Access Memory (RAM) (not shown), as is known in the art.

As shown in FIG. 2, processor 2100 is functionally comprised of a DNS tracker 2110, a data processor 2120. Optionally, the processor may also have a World Wide Web (WWW or “web”) server 2130.

Data processor 2120 interfaces with storage media 2200 and network interface 2300. The data processor 2120 enables processor 2100 to locate data on, read data from, and writes data to, these components.

World Wide Web server 2130 provides an easy-to-use user-interface for collection server 2000.

DNS tracker 2110 is the structure that enables collection, parsing and analysis of Domain Name System information from a network, and may further comprise: a DNS log collector 2112, a DNS log parser 2114, a SQL Server Integration Services (SSIS) 2116, and a DNS analyzer 2118.

DNS log collector 2112 is the interface that allows DNS tracker 2110 to access the DNS logs of DNS servers 1200.

DNS log parser 2114 is a structure configured parse and analyze the DNS logs retrieved by DNS log collector 2112.

DNS analyzer 2118 analyzes the DNS logs.

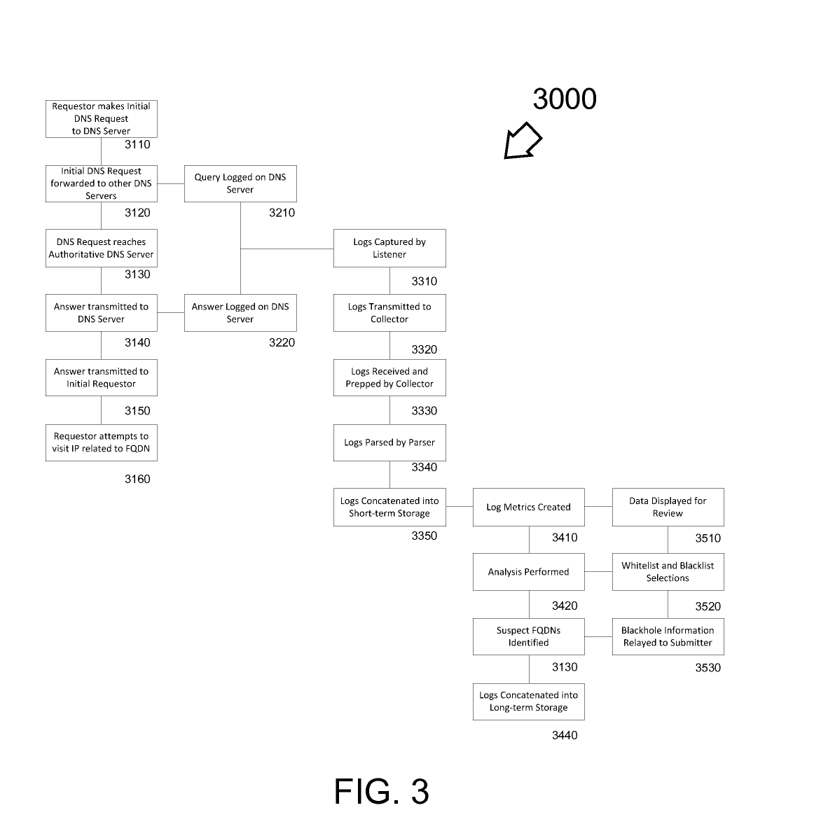

The functionality of all the DNS tracker 2110 structures is elaborated in greater detail in FIG. 3.

These structures may be implemented as hardware, firmware, or software encoded on a computer readable medium, such as storage media 2200. Further details of these components are described with their relation to method embodiments below.

Computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage media 2200 may be remotely located from processor 2100, and be connected to processor 2100 via a network such as a local area network (LAN), a wide area network (WAN), or the Internet.

In addition, as shown in FIG. 2, storage media 2200 may also contain a monitoring database 2210, an analysis database 2220, a history database 2230, and a malware database 2240. Monitoring database 2210 may contain watch tables and detail tables. Watch tables contain questionable, black, or unknown fully qualified domain names found. Detail tables contain recent DNS requests, usually between 0-2 days of requests. Analysis database 2220 contains the most recent months' worth of DNS requests. History database 2230 contains a history of older requests that are older than the analysis database 2220. Malware database 2240 contains a record of suspicious or known bad-traffic fully qualified domain names and/or IP addresses. Entries in the malware database 2240 may be discovered through investigation of suspicious activities, or imported from databases of known bad-traffic internet addresses. This allows for fast processing and analysis of new data as well as indefinite storage of detected malicious events and fast retrieval of that information as necessary.

It is understood by those familiar with the art that one or more of these databases 2210-2240 may be combined in a myriad of combinations.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows collection server 2000 to communicate with merchant 1100 and issuer 1200.

We now turn our attention to method or process embodiments of the present disclosure, FIG. 3. It is understood by those known in the art that instructions for such method embodiments may be stored on their respective computer-readable memory and executed by their respective processors. It is understood by those skilled in the art that other equivalent implementations can exist without departing from the spirit or claims of the invention.

Embodiments provide a tool for discovering malware and viruses within a network. FIG. 3 illustrates a process 3000 in which includes collection, parsing and analysis of Domain Name System information from a network, constructed and operative in accordance with an embodiment of the present disclosure. Within the flow chart of FIG. 3, each column is a method that may be performed by an entity. Blocks 3110-3160 are performed as part of a DNS lookup requested by end-user computer. Blocks 3210-3220 reflect the data logging that results from the DNS lookup. Blocks 3310-3350 cover DNS log collection by the collection server 2000. Furthermore, after DNS log data is collected by collection server 2000, analysis of the DNS log data may occur at a different computing device. For the sake of example, this disclosure will discuss a collection server 2000 embodiment that performs the analysis of the DNS log data. Blocks 3410-3440 detail the analysis of the collected DNS logs. Blocks 3510-3530 reflect actions performed based on the analysis of the collected DNS logs.

At block 3010, end user computer 1100 makes an initial DNS lookup request to a DNS server 1200A. The query is logged on the DNS server 1200A, block 3210. If DNS server 1200A does not have the DNS look up information, DNS server 1200A forwards the DNS lookup request to other DNS servers 1200B, block 3220. Eventually, the DNS request is forwarded to an authoritative DNS server 1200C, block 3130. Authoritative DNS server 1200C responds with an answer containing an IP address, block 3140. The answer is logged on the DNS server, block 3220. The answer is transmitted to the end-user computer 1100, block 3150, enabling the user computer 1100 to communicate with the IP address related to the fully qualified domain name, block 3160.

We now turn to a portion of process 3000 performed by collection server 2000, which includes collection of the DNS logs, analysis of the DNS logs, and actions taken based on the analysis.

At block 3310, the DNS logs are captured by a listener daemon running on the DNS server 1200. The DNS log information includes a DNS lookup entry containing an originating internet protocol (IP) address, a fully qualified domain name, and a resolved internet protocol address. The listener daemon transmits the DNS logs to a DNS log collector 2112 on the collection server 2000, block 3320. The transmission may occur by a Secure File Transfer Protocol (SSH FTP) tunnel, Secure Sockets Layer (SSL) or other method of data movement or transmission known in the art.

In some embodiments, the listener daemon works in conjunction with a monitoring device attached to a mirrored port in a switch that forwards duplicate DNS traffic to the collection server 2000. Such a monitoring device has multiple network interface ports installed. One of these ports may be reserved for management and the remainder may be connected to one or more switches to monitor traffic. Monitoring devices in the network may be configured so that a copy of the traffic flows to the device by way of a monitoring port on the managed switch. This prevents any traffic delays and removes any possibility for the device to create connectivity problems. It is understood that monitoring devices may run Microsoft Windows, Linux, or other operating systems known in the art.

In other embodiments, the listener daemon works to collect information right off of DNS servers without collection hardware or configuring sensors and switch monitoring. In such an embodiment, the DNS server 1200 are configured to create detailed DNS log files. Some DNS servers 1200, such as Microsoft DNS servers, use a mechanism that allows for temporary logging of DNS activity on a server for debugging purposes. When the DNS log file grows to the configured maximum size, the DNS server 1200 overwrites the log files (C:\WINDOWS\system32\dns\backup\dns.log), and resets other specified log files. To collect the logs, the file must be fetched when it is written to disk and archived before being overwritten by the next instance. The listener daemon automates the capture of DNS logs from such DNS servers, overcoming the design limitations of the native server DNS logging facility. The monitor daemon monitors the log creation process and collects the backup file each time it is overwritten.

In BIND DNS embodiments, the monitor daemon may be configured to log and capture the requests and answers sent to/from the DNS server.

DNS tracker 2110 receives the transmitted log, block 3330, and DNS log parser 2114 parses the DNS logs into a relational database (referred to as the analysis database 2220), block 3340. Analysis database 2220 may be any relational database known in the art, such as a SQL database or non-relational database such as MongoDB. In some embodiments, the logs are concatenated into short-term storage on a non-transitory computer readable medium 2200, block 3350. In some embodiments, such logs may be stored in a history database 2230.

Once the logs are parsed into the analysis database 2220, they may be subsequently analyzed and reviewed. At block 3410, SQL Server Integration Services 2116 pull log data from analysis database 2220 and expands it into fact and dimension tables, processes the dimension tables so that they are ready for cubing, and process OLAP cubes so that the data can be analyzed by DNS analyzer 2118.

Analysis of the processed DNS log data by DNS analyzer 2118 occurs at block 3420. As part of the analysis, the DNS log data can be mined to locate potentially malicious behavior.

Some indices of malicious behavior include domains with an excessive visit count, domains with a very short TTL, domains resolving to suspicious name servers and randomly generated domain names. Name servers and domains may be compared to a black list of suspicious name servers and domains stored in malware database 2240, for example.

In essence, the common data flow analysis for hunting for known or unknown malware may be broken into a series of sub-processes for handling known malicious domains or hunting (determining) potential malicious domains.

Handling known malicious domains occurs when an FQDN or IP address that has been part of another alert, such as a black list entry in malware database 2240. Lookups are done against the detail tables to ensure that the most complete data is available. A search may be performed by sorting with Requesting IP, then Requested Domain and comparing with Requested Domains requesting the Requesting IP.

Hunting or determining malicious traffic involves searching for suspicious activity, such as items that show up on a watch list, or domains with Internet Protocol addresses that resolve to suspect countries, for example. Other types of suspicious activities may include: sub-domains or domains that fail to serve a place in the organization, fully qualified domain names that have not been seen in the organization before (i.e., “new” addresses), and domain names that are common across organizations that share visit patterns or behavior.

Once suspicious or known-bad traffic is identified at block 3430, the generating client is tracked and investigated further. If there are proxy server between the DNS server and the originating client, logs for those intermediate servers may be utilized in order to determine the original client, block 3440.

The suspicious or bad traffic may be viewed by administrators at block 3510. In some embodiments, the traffic is viewed as reports via a world wide web server 2130. The administrator may modify white list and black lists at block 3520, and may relay subsequent DNS black hole list (DNSBL) information to end-user computers 1100 at block 3530. A DNS black hole list is publicized list of IP addresses known to be sources of spam, malware or other “bad” IP addresses, which can be used to create a network blacklist to filter out e-mail, World Wide Web, file transfer, or any other communication originating from or to these addresses.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method comprising:
collecting, via a network interface, DNS log information from a DNS server, the DNS log information including a DNS lookup entry containing an originating internet protocol (IP) address, a fully qualified domain name, and a resolved internet protocol address;
extracting, with a processor, the DNS lookup entry from the DNS log information;
comparing, with the processor, the DNS lookup entry with a malware database entry;
analyzing recursive DNS requests made from multiple endpoints to identify new malware;
transmitting to the originating internet protocol address, via the network interface, a DNS black hole list entry when the resolved internet protocol address matches the malware database entry.

2. The method of claim 1, wherein the DNS log information is transmitted by a listener daemon running on the DNS server.

3. The method of claim 2, wherein the collection of DNS log information comes from a plurality of DNS servers.

4. The method of claim 3, wherein the collection of DNS log information is conducted via SSH File Transfer Protocol or Secure Sockets Layer (SSL).

5. The method of claim 4, wherein the malware database entry contains a malicious internet protocol address, a malicious fully qualified domain name or partial domain name.

6. The method of claim 5, wherein the DNS black hole list entry contains the resolved internet protocol address.

7. The method of claim 5, wherein the DNS black hole list entry contains the fully qualified domain name of the resolved internet protocol address.

8. A collection server comprising:
a network interface configured to collect DNS log information from a DNS server, the DNS log information including a DNS lookup entry containing an originating internet protocol (IP) address, a fully qualified domain name, and a resolved internet protocol address;
a processor configured to extract the DNS lookup entry from the DNS log information, to compare the DNS lookup entry with a malware database entry, to analyze recursive DNS requests made from multiple endpoints to identify new malware;
wherein the network interface is further configured to transmit to the originating internet protocol address, via the network interface, a DNS black hole list entry when the resolved internet protocol address matches the malware database entry.

9. The collection server of claim 8, wherein the DNS log information is transmitted by a listener daemon running on the DNS server.

10. The collection server of claim 9, wherein the collection of DNS log information comes from a plurality of DNS servers.

11. The collection server of claim 10, wherein the collection of DNS log information is conducted via SSH File Transfer Protocol or Secure Sockets Layer (SSL).

12. The collection server of claim 11, wherein the malware database entry contains an malware internet protocol address, a malware fully qualified domain name or partial domain name.

13. The collection server of claim 12, wherein the DNS black hole list entry contains the resolved internet protocol address.

14. The collection server of claim 12, wherein the DNS black hole list entry contains the fully qualified domain name of the resolved internet protocol address.

15. A non-transitory computer readable medium encoded with data and instructions, when executed by a computing device the instructions causing the computing device to:
collect, via a network interface, DNS log information from a DNS server, the DNS log information including a DNS lookup entry containing an originating internet protocol (IP) address, a fully qualified domain name, and a resolved internet protocol address;
extract, with a processor, the DNS lookup entry from the DNS log information;
compare, with the processor, the DNS lookup entry with a malware database entry;
analyze recursive DNS requests made from multiple endpoints to identify new malware;
transmit to the originating internet protocol address, via the network interface, a DNS black hole list entry when the resolved internet protocol address matches the malware database entry.

16. The non-transitory computer readable medium of claim 15, wherein the DNS log information is transmitted by a listener daemon running on the DNS server.

17. The non-transitory computer readable medium of claim 16, wherein the collection of DNS log information comes from a plurality of DNS servers.

18. The non-transitory computer readable medium of claim 17, wherein the collection of DNS log information is conducted via SSH File Transfer Protocol or Secure Sockets Layer (SSL).

19. The non-transitory computer readable medium of claim 18, wherein the malware database entry contains a malicious internet protocol address, a malicious fully qualified domain name or partial domain name.

20. The non-transitory computer readable medium of claim 19, wherein the DNS black hole list entry contains the resolved internet protocol address.
